(19) United States
(12) Patent Application Publication
(10) Pub. No.: US 2015/0373100 A1
(43) Pub. Date: Dec. 24, 2015

(54) CONTEXT SHARING BETWEEN DIFFERENT CLIENTS

(71) Applicants: Pavel Kravets, Ashdod (IL); Itzik Hav, Herzelya (IL)

(72) Inventors: Pavel Kravets, Ashdod (IL); Itzik Hav, Herzelya (IL)

(21) Appl. No.: 14/308,945

(22) Filed: Jun. 19, 2014

(51) Int. Cl. H04L 29/08; H04L 29/06

(52) U.S. Cl. CPC H04L 67/1091; H04L 67/42; H04L 67/1029

(57) ABSTRACT

The present disclosure describes methods, systems, and computer program products for providing context sharing between different clients. One computer-implemented method includes receiving a data state change from a client application associated with a client, the state change indicating a change in data contextually relevant to other client applications, generating, by operation of a hardware processor, client state data reflecting the data state change, transmitting the client state data to a server to be persisted as state data, and receiving the state data at another client, the another client aligning the state of associated application to reflect the state data.

### BACKGROUND

In traditional client/server architectures where multiple users use application compositions (e.g., “mashups”) with some content in common, issues arise when different users are working on the same or related objects (e.g., documents, processes, data, tasks, etc.). For example, a first user and a second user using different client computing devices and working on the same travel request form or a group of documents to schedule a vacation. Concurrent editing of the same or related objects can result in lost work due to parallel overriding of changes by different users, uncertainty as to the “dirtiness” of the objects when accessed by a user, incorrect data, inconsistent views of the same or related objects, and the like. The issues become especially acute when resulting in monetary loss, rework, customer confusion and dissatisfaction, a poor user experience, and/or rejection of applications/data in favor of competing products.

### SUMMARY

The present disclosure relates to computer-implemented methods, computer-readable media, and computer systems for providing context sharing between different clients. One computer-implemented method includes receiving a data state change from a client application associated with a client, the state change indicating a change in data contextually relevant to other client applications, generating, by operation of a hardware processor, client state data reflecting the data state change, transmitting the client state data to a server to be persisted as state data, and receiving the state data at another client, the another client aligning the state of associated application to reflect the state data.

Other implementations of this aspect include corresponding computer systems, apparatuses, and computer programs recorded on one or more computer storage devices, each configured to perform the actions of the methods. A system of one or more computers can be configured to perform particular operations or actions by virtue of having software, firmware, hardware, or a combination of software, firmware, or hardware installed on the system that in operation causes or causes the system to perform the actions. One or more computer programs can be configured to perform particular operations or actions by virtue of including instructions that, when executed by data processing apparatus, cause the apparatus to perform the actions.

The foregoing and other implementations can each optionally include one or more of the following features, alone or in combination:

A first aspect, combinable with the general implementation, comprising registering the client application with a client framework to permit communication between the client application and the client framework.

A second aspect, combinable with any of the previous aspects, comprising registering the client with a server framework to permit communication between the client and server.

A third aspect, combinable with any of the previous aspects, comprising transmitting the client state data to the server.

A fourth aspect, combinable with any of the previous aspects, wherein the server operates in one of broadcast mode or peer-to-peer mode.

A fifth aspect, combinable with any of the previous aspects, comprising analyzing received state data from the server to determine appropriate client applications on the another client to receive the state data.

A sixth aspect, combinable with any of the previous aspects, comprising transmitting last persisted state data to the client when the client application is initially started.

The subject matter described in this specification can be implemented in particular implementations so as to realize one or more of the following advantages. First, concurrent editing of an object/data is allowed by multiple users. Each user can perform edits and loss of work can be avoided. Each user also does not need to be aware of the dirtiness of the object/data. For example, a new order request can be made and committed and another user is informed. Second, concurrent editing of related objects/data is allowed by multiple users. Consistency of different user views is ensured for each related object/data. Third, user application collections in a mashup environment may (but is not required to) be identical. This increased flexibility for different user hardware/software configurations. Fourth, data required to align an environment context among multiple users does not require the usage of specific technology. Instead, different technologies, such as JAVASCRIPT Object Notation (JSON), can be leveraged for necessary data models/information structures to align each of different users to a similar state. The described subject matter can be considered hardware/software platform agnostic. Fifth, the server(s) hold no business logic and state data is typically not persisted for simplicity. The server receives and transfers state data message among clients. Other advantages will be apparent to those skilled in the art.

The details of one or more implementations of the subject matter of this specification are set forth in the accompanying drawings and the description below. Other features, aspects, and advantages of the subject matter will become apparent from the description, the drawings, and the claims.

### DESCRIPTION OF DRAWINGS

FIG. 1 is a block diagram illustrating an example distributed computing system (EDCS) for providing context sharing between different clients according to an implementation.

FIG. 2 is a block diagram illustrating an example client/server architecture for providing context sharing between different clients according to an implementation.

FIG. 3 is a flow chart illustrating a method for providing context sharing between different clients according to an implementation.

Like reference numbers and designations in the various drawings indicate like elements.

### DETAILED DESCRIPTION

The following detailed description is presented to enable any person skilled in the art to make, use, and/or practice the disclosed subject matter, and is provided in the context of one or more particular implementations. Various modifications to the disclosed implementations will be readily apparent to those skilled in the art, and the general principles defined herein may be applied to other implementations and applications without departing from scope of the disclosure. Thus, the present disclosure is not intended to be limited to the described and/or illustrated implementations, but is to be accorded the widest scope consistent with the principles and features disclosed herein.

Enterprise portals (EPs) allow integration of information, people, and processes across organizational boundaries. An EP provides a secure unified access point, often in the form of a web-based graphical user interface (GUI), and is designed to aggregate and personalize information through application-specific portals. The EP is a de-centralized content contribution, collaboration, and content management system, which keeps the information always updated. With a native application or other general access application, for example a web browser, EP users can begin work once they have been authenticated in the EP which offers a single point of access to information, enterprise applications, collaboration spaces, and services both inside and outside an organization.

EPs may present information from diverse sources on mobile or other devices in a unified and structured way, for example using HTML container documents, and provide additional services, such as dashboards, an internal search engine, e-mail, news, navigation tools, collaboration tools, and various other features. EPs are often used by enterprises for providing their employees, customers, and possibly additional users with a consistent look and feel, and access control and procedures for multiple applications, which otherwise would have been separate entities altogether.

This disclosure generally describes computer-implemented methods, computer-program products, and systems for providing context sharing between different clients, for example clients of an EP. A generic mechanism is described for sharing context in a composite application environment among users (e.g., aligning all clients to the same state in real-time or near-real-time) and is applicable for users using application compositions that have content in common. Each user is not required to have an identical set of composite applications as other users; a subset of applications for each particular user is envisioned where common content is used. For example, a first user could use a client with a human resources application, while a second user uses a second client without the human resource application but with a vacation planning application. The common data could be that of a particular employee. This increases flexibility for different user hardware/software configurations leveraged to use/process content of interest to one or more clients. The simplified example client/server architecture is provided for reasons of explanation and understanding and is not meant to limit the concepts to the provided examples.

In traditional client/server architectures where multiple users use application compositions (e.g., “mashups”) with some content in common, issues arise when different users are working on the same or related objects (e.g., documents, processes, data, tasks, etc.). For example, a first user and a second user using different client computing devices and working on the same travel request form or a group of documents to schedule a vacation. Concurrent editing of the same or related objects can result in lost work due to parallel overriding of changes by different users, uncertainty as to the “dirtiness” of the objects when accessed by a user, incorrect data, inconsistent views of the same or related objects, and the like. The issues become especially acute when resulting in monetary loss, rework, customer confusion and dissatisfaction, a poor user experience, and/or rejection of applications/data in favor of competing products.

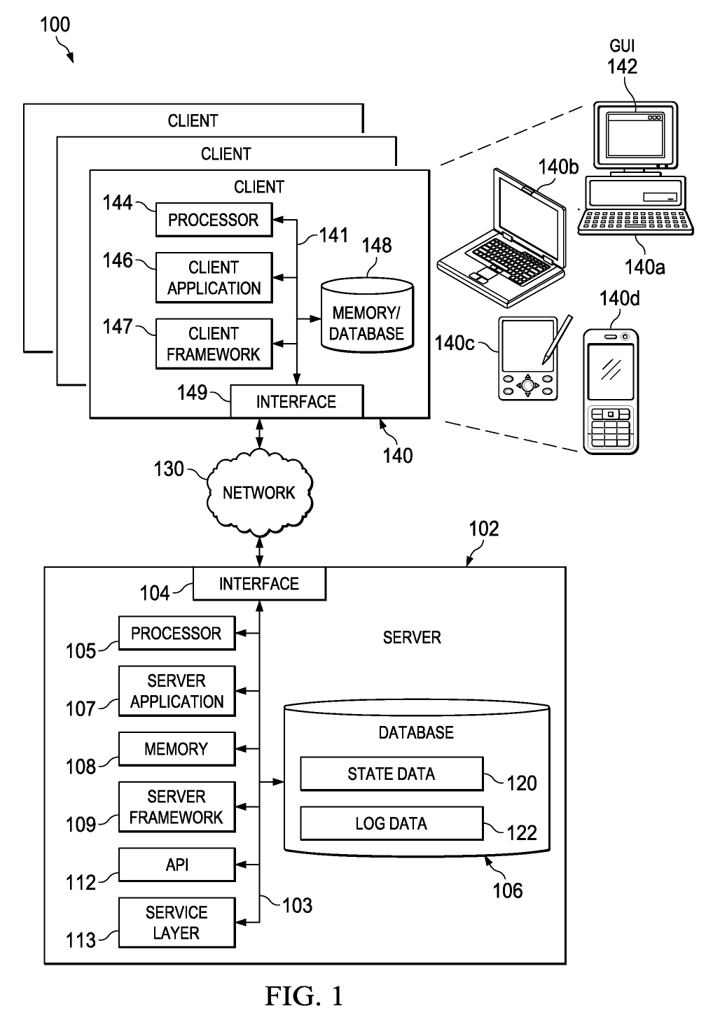

FIG. 1 is a block diagram illustrating an example distributed computing system (EDCS) 100 for providing context sharing between different clients according to an implementation. The illustrated EDCS 100 includes or is communicably coupled with a server 102 and a client 140 that communicate across a network 130. In some implementations, one or more components of the EDCS 100 may be configured to operate within a cloud-computing-based environment.

At a high level, the server 102 is an electronic computing device operable to receive, transmit, process, store, or manage data and information associated with the EDCS 100. In general, the server 102 provides functionality appropriate to a server, including database functionality and receiving/serving content and/or functionality from/to a client permitting, for example, context sharing between different clients as described herein. According to some implementations, the server 102 may also include or be communicably coupled with an e-mail server, a web server, a caching server, a streaming data server, a business intelligence (BI) server, and/or other server.

The server 102 is responsible for receiving, among other things, state data, requests, and/or content from one or more client applications 146 and/or client frameworks 147 associated with the client 140 of the EDCS 100. The server 102 is also responsible for acting as a coordinator for state data among multiple clients 140. Typically coordination activities include receipt of state data from and dispatch of state data to one or more clients 140. The server 102 can also respond to received requests, for example requested processed by a server application 107 and/or database 106.

In addition to requests received from the client 140, requests may also be sent to the server 102 from internal users, external or third-parties, other automated applications, as well as any other appropriate entities, individuals, systems, or computers. In some implementations, various requests can be sent directly to server 102 from a user accessing server 102 directly (e.g., from a server command console or by other appropriate access method).

Each of the components of the server 102 can communicate using a system bus 103. In some implementations, any and/or all the components of the server 102, both hardware and/or software, may interface with each other and/or the interface 104 over the system bus 103 using an application programming interface (API) 112 and/or a service layer 113. The API 112 may include specifications for routines, data structures, and object classes. The API 112 may be either computer-language independent or dependent and refer to a complete interface, a single function, or even a set of APIs. The service layer 113 provides software services to the EDCS 100. The functionality of the server 102 may be accessible for all service consumers using this service layer. Software services, such as those provided by the service layer 113, provide reusable, defined business functionalities through a defined interface. For example, the interface may be software written in JAVA, C++, or other suitable language providing data in extensible markup language (XML) format or other suitable format.

While illustrated as an integrated component of the server 102 in the EDCS 100, alternative implementations may illustrate the API 112 and/or the service layer 113 as stand-alone components in relation to other components of the EDCS 100. Moreover, any or all parts of the API 112 and/or the service layer 113 may be implemented as child or sub-modules of another software module, enterprise application, or hardware module without departing from the scope of this disclosure. For example, the API 112 could be integrated into the database 106, the server application 107, the server framework 109, and/or wholly or partially in other components of server 102 (whether or not illustrated).

The server 102 includes an interface 104. Although illustrated as a single interface 104 in FIG. 1, two or more interfaces 104 may be used according to particular needs, desires, or particular implementations of the EDCS 100. The interface 104 is used by the server 102 for communicating with other systems in a distributed environment—including within the EDCS 100—connected to the network 130; for example, the client 140 as well as other systems communicably coupled to the network 130 (whether illustrated or not). Generally, the interface 104 comprises logic encoded in software and/or hardware in a suitable combination and operable to communicate with the network 130. More specifically, the interface 104 may comprise software supporting one or more communication protocols associated with communications such that the network 130 or interface's hardware is operable to communicate physical signals within and outside of the illustrated EDCS 100.

The server 102 includes a processor 105. Although illustrated as a single processor 105 in FIG. 1, two or more processors may be used according to particular needs, desires, or particular implementations of the EDCS 100. Generally, the processor 105 executes instructions and manipulates data to perform the operations of the server 102. Specifically, the processor 105 executes the functionality required for providing context sharing between different clients.

The server 102 also includes a database 106 that holds data for the server 102, client 140, and/or other components of the EDCS 100. Although illustrated as a single database 106 in FIG. 1, two or more databases may be used according to particular needs, desires, or particular implementations of the EDCS 100. While database 106 is illustrated as an integral component of the server 102, in alternative implementations, database 106 can be external to the server 102 and/or the EDCS 100. In some implementations, database 106 can be configured to store one or more instances of state data 120, log data 122, and/or other appropriate data (e.g., user profiles, objects and content, client data, etc. —whether or not illustrated).

The state data 120 can be any data, including data representing objects (e.g., elements, fields, etc.) to permit one or more applications on a client computing device (e.g., client 140) to be configured/aligned to a state consistent with the state data. For example, the first user (e.g., a human resources manager) in the above-provided example using a client computing device with a human resources application could modify data indicating that all empolyee's permitted number of vacation days within the next year are increased by fourteen, while the second user (e.g., the first employee) using a second client computing device without the human resource application but with the vacation planning application would have the context of the vacation planning application updated to reflect that fourteen vacation days are available over the next year. In typical implementations, the state data 120 would be transmitted from the first user's client computing device to the server 102 and transmitted from the server 102 to the second user's client computing device where it would be used to align context of applications sharing the employee vacation-related data on both the first and second user's client computing devices. Note that in some instances there may be no common applications between the two users, but only contextual data that is used to align different applications (e.g., here first user only executes the human resources application and the second user only executes the vacation planning application). Note that for a third user (e.g, a second employee) using a third client computing device with the vacation planning applicaiton, the second employee could note that they now have twenty-one days of vacation available over the next year (seven from the prior year plus the fourteen just added by the first user). Note also that, for a fourth client computing device, the state data 120 may not be relevant and the server 102 may not transmit the state data to the fourth client computing device (or it can be transmitted to but ignored by the fourth client computing device application(s)). For example, the user of the fourth client computing device could be an independent contractor and a company's vacation policies are not applicable to the fourth client computing device user.

In typical implementations, the state data 120 is not persisted on the client computing devices, but is persisted on the server 102. Typically, the state data is present in currently running applications on a particular client computing device (and possibly temporarily in the memory/database of a client computing device—e.g., the memory/database 148 of the client 140). The state data 120 is typically not persisted on the client 140 however. State data 120 is typically persisted on the server 102, e.g., in the database 106 and/or memory 108. The persistence of the state data 120 on the server 102 permits, among other things, the server to repeatedly retry (if necessary) to transmit state data to a client 140 as well as to permit one or more clients to start up into a known state by accessing the state data 120. For example, two or more clients 140 could, on start-up, access persisted state data 120 to resume a training session where it was left off the previous day even if the client 140 that generated the final state data 120 did not resume the training session. In other words, the persisted data can be used to return a client 140 to a last-known good state.

State data 120 can be represented by any suitable data structure appropriate for the hardware and/or software used in the client/server architecture. In other words, the state data 120 is platform agnostic. For example, in some implementations, JAVASCRIPT Object Notation (JSON) models can be used for state data 120 information structures. In some implementations, the state data 120 can be converted to another format either by a server 102 or a client 140 if necessary (e.g., the state data 120 crosses a boundary of one type of network into another and the data structure needs conversion).

The log data 122 includes, in some implementations, any data necessary to inform a user of a failure to receive and/or transmit state data 120 and/or any other data to a client computing device. For example, the server 102 can attempt to transmit state data 120 to a client computing device and received a network failure message related to the transmission attempt. The server 102 can then log the transmission failure to the log data 122. In some implementations, the log data 122 can be used to analyze and attempt to re-transmit failed state data 120 transmission(s). In some implementations the log data 122 can be used to enhance the time period for state data 120 persistence (e.g., to allow the state data 120 to be later re-transmitted to a particular client computing device, or for some other reason). In some implementations, the log data 122 can be used to determine network bandwidth bottlenecks, client computing device data usage (e.g., receipt and/or transmission), and/or any other purpose consistent with this disclosure.

The server application 107 is an algorithmic software engine capable of providing, among other things, any appropriate function consistent with this disclosure for the server 102 (e.g., an enterprise resource planning (ERP) application, human resources application, vacation planning application, and/or other application). In some implementations, the server application 107 can be used for functions particular to the server 102 and/or one or more clients 140 (e.g., receiving from, processing, and/or transmitting data to a client 140). In some implementations, the server application 107 can provide and/or modify content provided by and/or made available to other components of the EDCS 100. In other words, the server application 107 can act in conjunction with one or more other components of the server 102 and/or EDCS 100 in responding to a request for content received from the client 140. For example, in some implementations the server application 107 can work in conjunction with the server framework 109 to provide context sharing between different clients.

Although illustrated as a single server application 107, the server application 107 may be implemented as multiple server applications 107. In addition, although illustrated as integral to the server 102, in alternative implementations, the server application 107 can be external to the server 102 and/or the EDCS 100 (e.g., wholly or partially executing on the client 140, other server 102 (not illustrated), etc.). Once a particular server application 107 is launched, the particular server application 107 can be used, for example by an application or other component of the EDCS 100 to interactively process received requests (e.g., from client 140). In some implementations, the server application 107 may be a network-based, web-based, and/or other suitable application consistent with this disclosure.

In some implementations, a particular server application 107 may operate in response to and in connection with at least one request received from other server applications 107, other components (e.g., software and/or hardware modules) associated with another server 102, and/or other components of the EDCS 100. In some implementations, the server application 107 can be accessed and executed in a cloud-based computing environment using the network 130. In some implementations, a portion of a particular server application 107 may be a web service associated with the server application 107 that is remotely called, while another portion of the server application 107 may be an interface object or agent bundled for processing by any suitable component of the EDCS 100. Moreover, any or all of a particular server application 107 may be a child or sub-module of another software module or application (not illustrated) without departing from the scope of this disclosure. Still further, portions of the particular server application 107 may be executed or accessed by a user working directly at the server 102, as well as remotely at a corresponding client 140. In some implementations, the server 102 or any suitable component of server 102 or the EDCS 100 can execute the server application 107.

The memory 108 typically stores objects and/or data associated with the purposes of the server 102 but may also be used in conjunction with the database 106 to store, transfer, manipulate, etc. objects and/or data. The memory 108 can also consistent with other memories within the EDCS 100 and be used to store data similar to that stored in the other memories of the EDCS 100 for purposes such as backup, caching, and/or other purposes.

The server framework 109 is responsible for acting as a coordinator in providing functionality for context sharing between different client computing devices. For example, the server framework 109 can be used to receive process, persist, and/or transmit client application state changes to other appropriate client computing devices. In some implementations, the server framework 109 can be used to register client computing devices and/or associated applications executing on the client computing devices for functionality to share context between different client computing devices.

The server framework 109 can operate in multiple different modes. For example, in a broadcast mode, the server framework 109 would broadcast any change received from any client to all other clients (regardless of which applications may or may not be executing on a particular client—the server framework 109 typically is not aware of applications associated with/running on each client). In a peer-to-peer mode, the server framework 109 can intelligently determine which clients should receive particular data (e.g., from other particular clients) but not have knowledge of applications associated with/running on each client. For example, a first client 140 can register with the server 102 to receive update data from only a second and a third client 140. In some implementations, in both broadcast and peer-to-peer mode, the server framework 109 can have knowledge of applications on each client to receive state data changes and use this knowledge to more efficiently transmit data.

In some implementations, the server framework 109 can include libraries, applications, services, objects, data, and the like used to provide functionality described by this disclosure for server-provided functionality for context sharing between different clients. In some implementations, the server framework 109 can be implemented in JAVASCRIPT or other scripting language. In some implementations, the server framework 109 can be leveraged by the server application 107 and/or other components of the EDCS 100 (e.g., other servers 102 and/or clients 140), particularly by other components of server 102. For example, the API 112 and/or service layer 113 can be used to access libraries, applications, services, etc. associated with the server framework 109. In some implementations, the server application 107, server framework 109, and/or database 106 can perform some type of pre-processing before transmitting any data (e.g., state data 120, log data 122, and/or other data) to the client application 146 and/or client framework 147. In some implementations, the server framework 109 can use a push notification type messaging system to push data to clients 140 (e.g., a client framework on each client 140 can register or be registered to receive the push notifications from the server 102).

The client 140 may be any computing device operable to connect to and/or communicate with at least the server 102. In general, the client 140 comprises an electronic computing device operable to receive, transmit, process, and store any appropriate data associated with the EDCS 100, for example, the server application 107. More particularly, among other things, the client 140 can collect content from the client 140 and upload the collected content to the server 102 for integration/processing into/by the server application 107 and/or the server framework 109. The client typically includes a processor 144, a client application 146, client framework 147, a memory/database 148, and/or an interface 149 interfacing over a system bus 141.

In some implementations, the client application 146 can use parameters, metadata, and other information received at launch to access a particular set of data from the server 102 and/or other components of the EDCS 100. Once a particular client application 146 is launched, a user may interactively process a task, event, or other information associated with the server 102 and/or other components of the EDCS 100. For example, the client application 146 can generate and transmit a particular database request to the server 102.

The client application 146 is any type of application that allows the client 140 to navigate to/from, request, view, create, edit, delete, administer, and/or manipulate content associated with the server 102 and/or the client 140. For example, the client application 146 can present GUI displays and associated data (e.g., contextual data from one or more other clients 140) to a user that is generated/transmitted by the server 102 (e.g., the server application 107, server framework 109, and/or database 106). In some implementations, the client application 146 can work in conjunction with the client framework 147 to collect contained client application(s) 146 state(s) and to transmit the collected state(s) to the server 102.

In some implementations, the client application 146 can be registered with the client framework 147 to publish state data from the client application 146 to the client framework 147 and/or to receive appropriate state data 120 once received from the client 102. In other implementations, the client framework can provide an API (e.g., an open source-type/open-standard API for use with applications), functions, etc. to allow client applications 146 to publish client application state changes with the client framework 147.

In some implementations, the client application 146 can also be used perform administrative functions related to the server application 107, server framework 109, database 106, and/or the server 102 in general. For example, the server application 107 can generate and/or transmit administrative pages to the client application 146 based on a particular user login, request, etc. to allow access to state data 120, log data 122, and/or other data on the server 102.

Further, although illustrated as a single client application 146, the client application 146 may be implemented as multiple client applications in the client 140. For example, there may be a native client application and a web-based (e.g., HTML) client application depending upon the particular needs of the client 140 and/or the EDCS 100.

The client framework 147 can be similar to the server framework 109 described above, but used for particular purpose associated with the client 140. In some implementations, the client framework 147 can be implemented in JAVASCRIPT or other scripting language and execute in the client application 146 (e.g., a browser). In some implementations, the client framework 147 can be used to register the associated client 140 with one or more servers 102 and/or other clients 140 for functionality to share context between different clients. For example, the client 140 can register for particular state data 120 associated with one or more client applications 146, etc. The client 140 can also have multiple simultaneous registrations for state data 120 depending on the associated client applications 146, users (e.g., role, permission level, etc.), locality, type of hardware, etc. In other implementations, the client framework forwards all received state date 120 to all client applications 146 and it is up to the client applications 146 to determine the applicability of the state data to the client application 146. In some implementations, a separate client framework 147 is associated with each client application 146 (e.g., 1:1 correspondence between a client framework 147 and a browser—client application 146).

The client framework 147 can be used by the client application 146 and/or other elements of the client 140 and/or server 102 (including other clients 140 and/or servers 102) to manage a state of each client 140 client applications 146 composition (i.e., mashup), collect one or more states of client applications 146 and transmit the collected state to one or more servers 102, and/or receive transmitted state data 120 from the one or more servers 102 and notify appropriate client applications 146 associated with the client 140 based on the state data 120. For example, a client framework 147 could be a plugin that runs with a client application 146 browser. Note that in some applications, not all client applications 146 may be associated with the client framework 147 and/or functionality to provide context sharing between different clients; in which case the non-associated client application(s) 146 can be ignored and/or ignore any data received from server 102 and/or instructions received from the client framework 147.

In some implementations, the client framework 147 can act as an interface between the server 102 and the client application 146 for some or all data transmitted to and/or from the server 102. In some implementations, the client application 146 and/or client framework 147 can perform some type of pre-processing before transmitting any data (e.g., state data, etc.) to the server application 107 and/or server framework 109.

The client framework 147 generates and transmits notifications to clients associated with the client 140 once state data is received by the client 140. For example, the client framework 147 is aware of client applications 146 executing on the client 140 and which client applications 146 the received state data 120 is applicable to. The client framework 147 then transmits notifications to the appropriate clients with the appropriate state data so that the client applications 146 can update their state.

In some implementations, the client framework 147 can initiate presentation of GUI displays and associated data to a user using the client application 146 and/or memory/database 148 to display data, accept user input, and transmit data (e.g., as state data) to the server 102 for dissemination to appropriate clients 140.

The interface 149 is used by the client 140 for communicating with other computing systems in a distributed computing system environment, including within the EDCS 100, using network 130. For example, the client 140 uses the interface to communicate with a server 102 as well as other systems (not illustrated) that can be communicably coupled to the network 130. The interface 149 may be consistent with the above-described interface 104 of the server 102. The processor 144 may be consistent with the above-described processor 105 of the server 102. Specifically, the processor 144 executes instructions and manipulates data to perform the operations of the client 140, including the functionality required to send requests to the server 102 and to receive and process responses from the server 102.

The memory/database 148 typically stores objects and/or data associated with the purposes of the client 140 but may also be consistent with the above-described database 106 and/or memory 108 of the server 102 or other memories within the EDCS 100 and be used to store data similar to that stored in the other memories of the EDCS 100 for purposes such as backup, caching, and the like. Although illustrated as a combined memory/database, in some implementations, the memory and database can be separated (e.g., as in the server 102).

Further, the illustrated client 140 includes a GUI 142 that interfaces with at least a portion of the EDCS 100 for any suitable purpose. For example, the GUI 142 (illustrated as associated with client 140a) may be used to view data associated with the client 140, the server 102, or any other component of the EDCS 100. In particular, in some implementations, the client application 146 may render GUI interfaces received from the server application 107, client framework 147, and/or data retrieved from any element of the EDCS 100.

There may be any number of clients 140 associated with, or external to, the EDCS 100. For example, while the illustrated EDCS 100 includes one client 140 communicably coupled to the server 102 using network 130, alternative implementations of the EDCS 100 may include any number of clients 140 suitable to the purposes of the EDCS 100. Additionally, there may also be one or more additional clients 140 external to the illustrated portion of the EDCS 100 that are capable of interacting with the EDCS 100 using the network 130. Further, the term “client” and “user” may be used interchangeably as appropriate without departing from the scope of this disclosure. Moreover, while the client 140 is described in terms of being used by a single user, this disclosure contemplates that many users may use one computer, or that one user may use multiple computers.

The illustrated client 140 (example configurations illustrated as 140a-140d) is intended to encompass any computing device such as a desktop computer/server, laptop/notebook computer, wireless data port, smart phone, personal data assistant (PDA), tablet computing device, one or more processors within these devices, or any other suitable processing device. For example, the client 140 may comprise a computer that includes an input device, such as a keypad, touch screen, or other device that can accept user information, and an output device that conveys information associated with the operation of the server 102 or the client 140 itself, including digital data, visual and/or audio information, or a GUI 142 (illustrated by way of example only with respect to the client 140a).

In some implementations, the client framework 147 can generate log data (not illustrated) to persist on the memory/database 148. The log data can be used to determine failures to transmit state data to the server 102, other clients 140, etc. The log data can also be used to re-schedule transmission of state data to the server 102, other clients 140, etc. and/or any other functionality consistent with this disclosure.

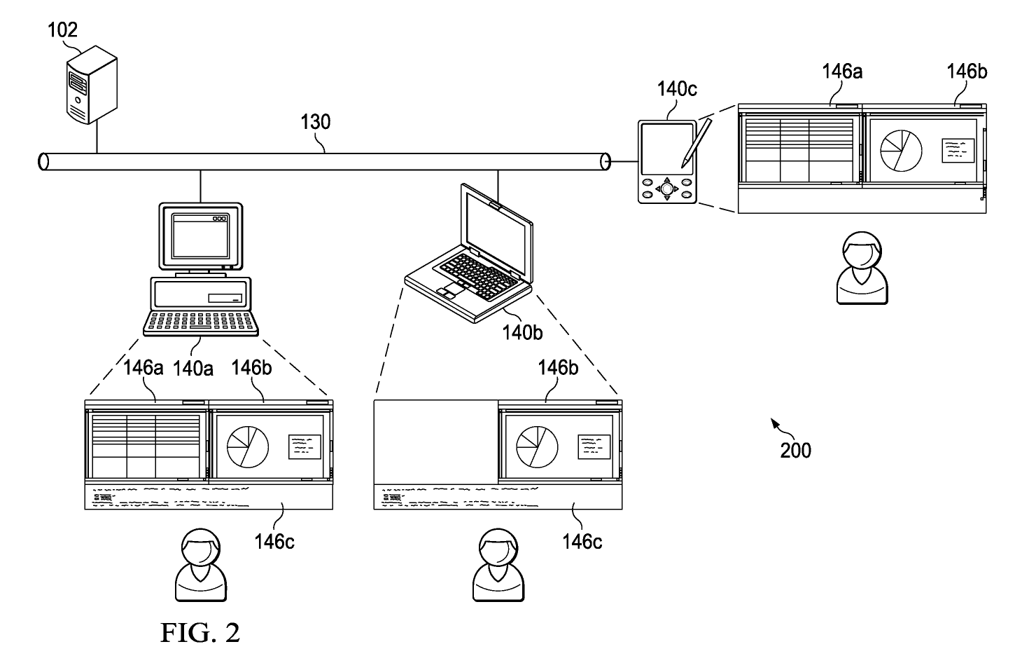

FIG. 2 is a block diagram 200 illustrating an example client/server architecture for providing context sharing between different clients according to an implementation. Clients 140a, 140b, and 140c are connected to server 102 using network 130. As illustrated, each client is executing a composite application environment (a mashup). For example, client 140a is executing client applications 146a, 146b, and 146c; client 140b is executing client applications 146b and 146c; and client 140c is executing client applications 146a and 146b.

The server 102 acts as a common server mediator between three clients 140a, 140b, and 140c. As an example, a client 140a user selects an entry from client application 146a. This action affects other applications in its composite environment (e.g., client application 146b displays a pie chart relevant to the selected entry in client application 146a and client application 146c displays textual data relevant to the selected entry). As a result, the state of client 140a is modified. The client framework 147 is notified by the client application 146a of the state change in the client application 146a and creates a state data representation (e.g., a data object) of the new state. The state data is then transmitted to the server 102 using network 130.

Server 102 receives the state data from client 140a. The state data is persisted in database 106 as state data 120 by the server framework 109. The server framework 109 is then used to transmit the state data to appropriate clients on the shared session (e.g., clients that have registered for state data associated with the particular application, data of a particular type, etc.). For the purposes of this example, all clients receive the state data transmitted by the server 102. Note that the server 102 holds/executes no business logic from any of the client applications in the example. The server 102 simply receives, processes, and passes through state data to appropriate clients 140.

When client 140b receives the state data 120, the client framework 147 associated with client 140b generates and send notifications to the client applications (146b and 146c) executing on client 140b with data applicable to each particular client application. Client applications 146b and 146c then align their state as follows:
Client application 146b displays a pie chart that is relevant to the selected entry on client 140a and client application 146c displays textual data relevant to the selected entry on client 140a.
This is performed even though client 140b does not execute client application 146a as does client 140a.

In the same way, client applications 146a and 146b associated with client 140c align their states according to the received state data 120.

In a case where two or more users change a state at the same time (or a single user changes multiple states where a first would take longer to complete than a second and the state changes are processed in parallel), a temporary locking mechanism, event synchronization mechanism could be used to ensure that one state data 120 change completes prior to the next state data 120 change being processed. In this instance, the granularity of a lock/event synchronization mechanism would be minimal (and user/administrative customizable in some instances). In some implementations, users could be sent a notification (e.g., a popup message or the like) to inform them a lock/synch occurred due to multiple changes that occurred. In some instances, the notifications could identify the changes that occurred, which user generated the changes, and/or any other data consistent with this this disclosure.

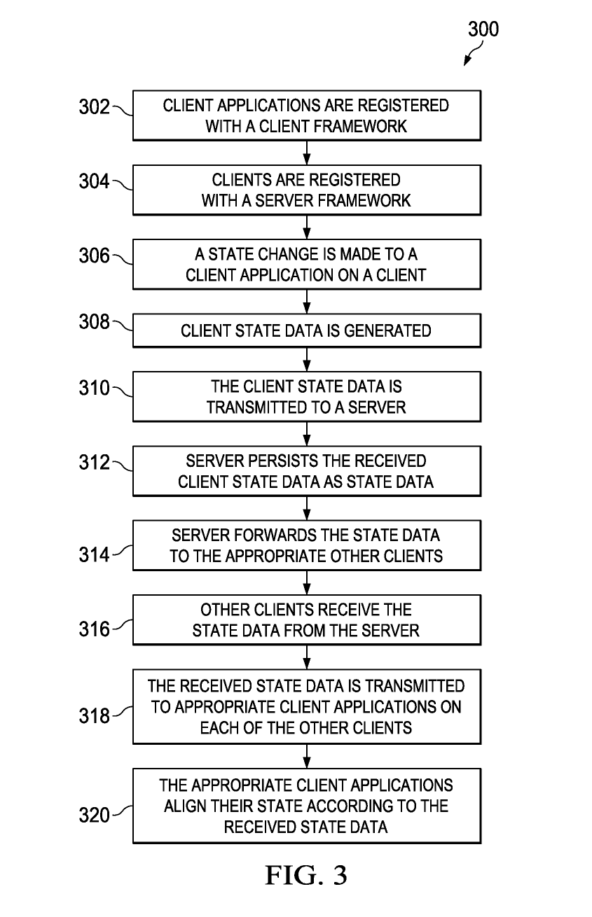

FIG. 3 is a flow chart illustrating a method 300 for providing context sharing between different clients according to an implementation. For clarity of presentation, the description that follows generally describes method 300 in the context of FIGS. 1-2. However, it will be understood that method 300 may be performed, for example, by any other suitable system, environment, software, and hardware, or a combination of systems, environments, software, and hardware as appropriate. In some implementations, various steps of method 300 can be run in parallel, in combination, in loops, and/or in any order.

At 302, client applications associated with each client are registered with an associated client framework for particular types of relevant data. From 302, method 300 proceeds to 304.

At 304, each client is registered with a server framework. In some implementations, the registration of the client with the server can also specify which type of data is relevant/applicable for each client (e.g., gathered from the registrations of 302). From 304, method 300 proceeds to 306.

At 306, a state change is made to a client application on a client. From 306, method 300 proceeds to 308.

At 308, client state data is generated by the client framework. From 308, method 300 proceeds to 310.

At 310, the client state data is transmitted a server for relay to other contextually-relevant clients. From 310, method 300 proceeds to 312.

At 312, the server persists the received client state data as state data. From 312, method 300 proceeds to 314.

At 314, the server forwards the state data to other contextually-relevant clients. From 314, method 300 proceeds to 316.

At 316, the other contextually-relevant clients receive the state data. From 316, method 300 proceeds to 318.

At 318, the received state data is processed and transmitted to appropriate applications on each of the contextually-relevant clients. For example, the client framework on each contextually-relevant client can process the state data and determine which associated application on the client should receive the state data. From 318, method 300 proceeds to 320.

At 320, the client applications for which the state data is relevant align their states consistent with the received state data. From 320, method 300 stops.

In some implementations, the described subject matter can be enhanced to store a shared environment state at any point. For example, a client with sufficient privileges can trigger a state save. This has the effect of performing one or more of the following:
Generating state data for the triggering user's client.
Transmitting a message to each other client (or to the server to transmit a request to other clients) to also generate state data for their client.
The server generating state data for its current state.
The generated state data for each client and/or server being persisted on the server and/or one or more clients for recovery.

With the saved state data, the system can be quickly aligned to repeat a live demonstration, a particular point in a presentation, process, etc. Note that the shared state could also be used by a single client to recover itself to a prior state (or to a prior state of another client) that has already been terminate or to a current ongoing state (e.g., if a client was disconnected due to a network error, etc.). The sharing of the state data can be synchronous or asynchronous.

In some implementations, the ability to influence data on other clients may be partially or wholly restricted by permissions, user role, etc. For example, a user on a first client may be able to affect data on their client applications, but these changes are not transmitted to other clients, but changes from a second, third, etc. client can be received and reflected on the first client. In another configuration, the user on the first client can transmit changes on a particular client application to the server, but not changes from all client applications.

Implementations of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible, non-transitory computer-storage medium for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example, a programmable processor, a computer, or multiple processors or computers. The apparatus can also be or further include special purpose logic circuitry, e.g., a central processing unit (CPU), a FPGA (field programmable gate array), or an ASIC (application-specific integrated circuit). In some implementations, the data processing apparatus and/or special purpose logic circuitry may be hardware-based and/or software-based. The apparatus can optionally include code that creates an execution environment for computer programs, e.g., code that constitutes processor firmware, a protocol stack, a database management system, an operating system, or a combination of one or more of them. The present disclosure contemplates the use of data processing apparatuses with or without conventional operating systems, for example LINUX, UNIX, WINDOWS, MAC OS, ANDROID, IOS or any other suitable conventional operating system.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network. While portions of the programs illustrated in the various figures are shown as individual modules that implement the various features and functionality through various objects, methods, or other processes, the programs may instead include a number of sub-modules, third-party services, components, libraries, and such, as appropriate. Conversely, the features and functionality of various components can be combined into single components as appropriate.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., a CPU, a FPGA, or an ASIC.

Computers suitable for the execution of a computer program can be based on general or special purpose microprocessors, both, or any other kind of CPU. Generally, a CPU will receive instructions and data from a read-only memory (ROM) or a random access memory (RAM) or both. The essential elements of a computer are a CPU for performing or executing instructions and one or more memory devices for storing instructions and data. Generally, a computer will also include, or be operatively coupled to, receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a global positioning system (GPS) receiver, or a portable storage device, e.g., a universal serial bus (USB) flash drive, to name just a few.

Computer-readable media (transitory or non-transitory, as appropriate) suitable for storing computer program instructions and data include all forms of non-volatile memory, media and memory devices, including by way of example semiconductor memory devices, e.g., erasable programmable read-only memory (EPROM), electrically-erasable programmable read-only memory (EEPROM), and flash memory devices; magnetic disks, e.g., internal hard disks or removable disks; magneto-optical disks; and CD-ROM, DVD+/−R, DVD-RAM, and DVD-ROM disks. The memory may store various objects or data, including caches, classes, frameworks, applications, backup data, jobs, web pages, web page templates, database tables, repositories storing business and/or dynamic information, and any other appropriate information including any parameters, variables, algorithms, instructions, rules, constraints, or references thereto. Additionally, the memory may include any other appropriate data, such as logs, policies, security or access data, reporting files, as well as others. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), LCD (liquid crystal display), LED (Light Emitting Diode), or plasma monitor, for displaying information to the user and a keyboard and a pointing device, e.g., a mouse, trackball, or trackpad by which the user can provide input to the computer. Input may also be provided to the computer using a touchscreen, such as a tablet computer surface with pressure sensitivity, a multi-touch screen using capacitive or electric sensing, or other type of touchscreen. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The term “graphical user interface,” or “GUI,” may be used in the singular or the plural to describe one or more graphical user interfaces and each of the displays of a particular graphical user interface. Therefore, a GUI may represent any graphical user interface, including but not limited to, a web browser, a touch screen, or a command line interface (CLI) that processes information and efficiently presents the information results to the user. In general, a GUI may include a plurality of user interface (UI) elements, some or all associated with a web browser, such as interactive fields, pull-down lists, and buttons operable by the business suite user. These and other UI elements may be related to or represent the functions of the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of wireline and/or wireless digital data communication, e.g., a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11 a/b/g/n and/or 802.20, all or a portion of the Internet, and/or any other communication system or systems at one or more locations. The network may communicate with, for example, Internet Protocol (IP) packets, Frame Relay frames, Asynchronous Transfer Mode (ATM) cells, voice, video, data, and/or other suitable information between network addresses.

The computing system can include clients and servers. A client and server are generally remote from each other and typically interact through a communication network. The relationship of client and server arises by virtue of computer programs running on the respective computers and having a client-server relationship to each other.

In some implementations, any or all of the components of the computing system, both hardware and/or software, may interface with each other and/or the interface using an application programming interface (API) and/or a service layer. The API may include specifications for routines, data structures, and object classes. The API may be either computer language independent or dependent and refer to a complete interface, a single function, or even a set of APIs. The service layer provides software services to the computing system. The functionality of the various components of the computing system may be accessible for all service consumers via this service layer. Software services provide reusable, defined business functionalities through a defined interface. For example, the interface may be software written in JAVA, C++, or other suitable language providing data in extensible markup language (XML) format or other suitable format. The API and/or service layer may be an integral and/or a stand-alone component in relation to other components of the computing system. Moreover, any or all parts of the service layer may be implemented as child or sub-modules of another software module, enterprise application, or hardware module without departing from the scope of this disclosure.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation and/or integration of various system modules and components in the implementations described above should not be understood as requiring such separation and/or integration in all implementations, and it should be understood that the described program components and systems can generally be integrated together in a single software product or packaged into multiple software products.

Particular implementations of the subject matter have been described. Other implementations, alterations, and permutations of the described implementations are within the scope of the following claims as will be apparent to those skilled in the art. For example, the actions recited in the claims can be performed in a different order and still achieve desirable results.

Accordingly, the above description of example implementations does not define or constrain this disclosure. Other changes, substitutions, and alterations are also possible without departing from the spirit and scope of this disclosure.

What is claimed is:

1. A computer-implemented method comprising:
receiving a data state change from a client application associated with a client, the state change indicating a change in data contextually relevant to other client applications;
generating, by operation of a hardware processor, client state data reflecting the data state change;
transmitting the client state data to a server to be persisted as state data; and
receiving the state data at another client, the another client aligning the state of associated application to reflect the state data.

2. The method of claim 1, comprising registering the client application with a client framework to permit communication between the client application and the client framework.

3. The method of claim 1, comprising registering the client with a server framework to permit communication between the client and server.

4. The method of claim 1, comprising transmitting the client state data to the server.

5. The method of claim 1, wherein the server operates in one of broadcast mode or peer-to-peer mode.

6. The method of claim 1, comprising analyzing received state data from the server to determine appropriate client applications on the another client to receive the state data.

7. The method of claim 1, comprising transmitting last persisted state data to the client when the client application is initially started.

8. A non-transitory, computer-readable medium storing computer-readable instructions executable by a computer and configured to:
receive a data state change from a client application associated with a client, the state change indicating a change in data contextually relevant to other client applications;
generate client state data reflecting the data state change;
transmit the client state data to a server to be persisted as state data; and
receive the state data at another client, the another client aligning the state of associated application to reflect the state data.

9. The medium of claim 8, comprising instructions to register the client application with a client framework to permit communication between the client application and the client framework.

10. The medium of claim 8, comprising instructions to register the client with a server framework to permit communication between the client and server.

11. The medium of claim 8, comprising instructions to transmit the client state data to the server.

12. The medium of claim 8, wherein the server operates in one of broadcast mode or peer-to-peer mode.

13. The medium of claim 8, comprising instructions to analyze received state data from the server to determine appropriate client applications on the another client to receive the state data.

14. The medium of claim 8, comprising instructions to transmit last persisted state data to the client when the client application is initially started.

15. A system, comprising:
a memory;
at least one hardware processor interoperably coupled with the memory and configured to:
receive a data state change from a client application associated with a client, the state change indicating a change in data contextually relevant to other client applications;
generate client state data reflecting the data state change;
transmit the client state data to a server to be persisted as state data; and
receive the state data at another client, the another client aligning the state of associated application to reflect the state data.

16. The system of claim 15, configured to register the client application with a client framework to permit communication between the client application and the client framework.

17. The system of claim 15, configured to register the client with a server framework to permit communication between the client and server.

18. The system of claim 15, configured to transmit the client state data to the server.

19. The system of claim 15, wherein the server operates in one of broadcast mode or peer-to-peer mode.

20. The system of claim 15, configured to:
analyze received state data from the server to determine appropriate client applications on the another client to receive the state data; and
transmit last persisted state data to the client when the client application is initially started.
